(19) United States
(12) Patent Application Publication
(10) Pub. No.: US 2025/0377927 A1
(43) Pub. Date: Dec. 11, 2025

(54) PROGRAM EXECUTING METHOD, ELECTRONIC DEVICE AND STORAGE MEDIUM

(71) Applicant: Beijing Zitiao Network Technology Co., Ltd., Beijing (CN)

(72) Inventors: Jianhua ZHU, Beijing (CN); Hengjie ZHENG, Beijing (CN)

(21) Appl. No.: 19/233,212

(22) Filed: Jun. 10, 2025

(30) Foreign Application Priority Data
Jun. 11, 2024 (CN) 202410749598.8

(51) Int. Cl. G06F 9/48

(52) U.S. Cl. CPC G06F 9/48

(57) ABSTRACT

The present disclosure relates to a program executing method, an electronic device and a storage medium. The method includes: in response to a program executing to a target point, determining structured information corresponding to the target point, wherein the structured information represents information of a database associated with the target point; determining target data from the associated database according to the structured information; and continuing to execute the program in response to the target data satisfying a preset condition.

### CROSS-REFERENCE TO RELATED APPLICATION

This application claims the priority to and benefits of the Chinese Patent Application, No. 202410749598.8, which was filed on Jun. 11, 2024. The aforementioned patent application is hereby incorporated by reference in its entirety.

### TECHNICAL FIELD

The present disclosure relates to a program executing method, a medium, an electronic device and a program product.

### BACKGROUND

At present, after executing of a business program is completed, relevant executing data will fall into a database for storage. For compliance governance requirements of business, it is usually necessary to conduct post-governance on the basis of executing data in the database. This not only leads to a lag of compliance governance, but also requires a lot of cost to revise results of non-compliance calls.

### SUMMARY

Embodiments of the present disclosure provide a program executing method, an apparatus, an electronic device and a storage medium.

In the first aspect, embodiments of the present disclosure provide a program executing method, which includes:
in response to a program executing to a target point, determining structured information corresponding to the target point, wherein the structured information represents information of a database associated with the target point;
determining target data from the associated database according to the structured information; and
continuing to execute the program in response to the target data satisfying a preset condition.

In the second aspect, embodiments of the present disclosure provide a program executing apparatus, which includes:
an information determination module, configured to in response to a program executing to a target point, determine structured information corresponding to the target point, wherein the structured information represents information of a database associated with the target point;
a data determination module, configured to determine target data from the associated database according to the structured information; and
an executing control module, configured to continue to execute the program in response to the target data satisfying a preset condition.

In the third aspect, embodiments of the present disclosure provide an electronic device, which includes:
one or more processors; and
a storage apparatus, configured to store one or more programs,
when the one or more programs are executed by the one or more processors, the one or more processors implement the program executing method according to embodiments of the present disclosure;
In the fourth aspect, embodiments of the present disclosure provide a non-transitory storage medium, which includes computer programs, when the computer programs are executed by a processor, the program executing method according to embodiments of the present disclosure.

### BRIEF DESCRIPTION OF DRAWINGS

The foregoing and other features, advantages, and aspects of various embodiments of the present disclosure will become more apparent with reference to the following detailed description when taken in conjunction with the accompanying drawings. Throughout the drawings, the same or similar reference numerals indicate the same or similar elements. It should be understood that the drawings are schematic and that components and elements are not necessarily drawn to scale.

FIG. 1 is a schematic flow diagram of a program executing method according to an embodiment of the present disclosure;

FIG. 2 is a schematic flow diagram of constructing structured information in the program executing method according to an embodiment of the present disclosure;

FIG. 3 is a schematic block diagram of data flow for constructing structured information in the program executing method according to an embodiment of the present disclosure;

FIG. 4 is a schematic structural diagram of a program executing apparatus according to an embodiment of the present disclosure; and

FIG. 5 is a schematic structural diagram of an electronic device according to an embodiment of the present disclosure.

### DETAILED DESCRIPTION

A reference will now be made to the accompanying drawings to describe the embodiments of the present disclosure in detail. While certain embodiments of the present disclosure have been illustrated in the accompanying drawings, it is to be understood that the disclosure may be implemented in various forms and should not be construed as limited to the embodiments set forth herein; rather, these embodiments are provided so that the disclosure will be understood more thoroughly and completely. It should be understood that the drawings and embodiments of the present disclosure are for illustrative purposes only and are not intended to limit the scope of protection of the present disclosure.

It should be understood that the various steps recited in the method embodiments of the present disclosure may be performed in a different order and/or in parallel. Moreover, method embodiments may include additional steps and/or omit performing the steps shown. The scope of protection of the present disclosure is not limited in this respect.

As used herein, the term “include” and variations thereof as used herein is open-ended, i.e. “including, but not limited to”. The term “on the basis of” means “based, at least in part, on”. The term “an embodiment” means “at least one embodiment”; the term “another embodiment” means “at least one further embodiment”; the term “some embodiments” means “at least some embodiments”. Relevant definitions of other terms will be given in the following description.

It should be noted that references to “first”, “second”, and the like in the present disclosure are merely used to distinguish between different apparatuses, modules, or units and are not intended to limit the order or interdependence of the functions performed by the devices, modules, or units.

It is noted that the references to “a”, “an”, and “a plurality” in the present disclosure are intended to be illustrative and not limiting, and a person skilled in the art will understand that they are to be interpreted as “one or more” unless the context clearly dictates otherwise.

The names of messages or information that interact between apparatuses in embodiments of the present disclosure are for illustrative purposes only and are not intended to limit the scope of such messages or information.

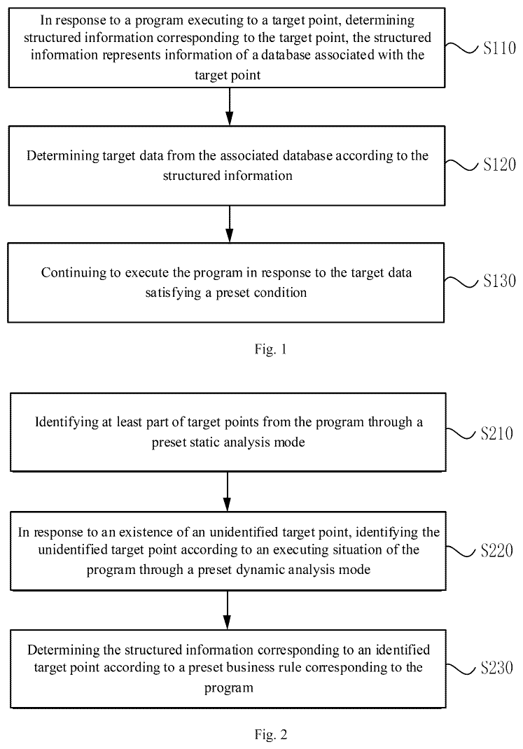

FIG. 1 is a schematic flow diagram of a program executing method according to an embodiment of the present disclosure. Embodiments of the present disclosure are applicable to situations where compliance governance occurs during executing of a business program. The method may be performed by a program executing apparatus, which may be implemented in the form of software and/or hardware and is configurable in an electronic device, e.g. in a background server or the like corresponding to the business program.

As shown in FIG. 1, the program executing method provided in the present embodiment may include:

S110, in response to a program executing to a target point, determining structured information corresponding to the target point, wherein the structured information represents information of a database associated with the target point.

In embodiments of the present disclosure, a program may include codes written in one or more assembly languages or a combination thereof, and corresponding business functions may be implemented by executing the program. Currently, there is a need for compliance governance for some businesses. For example, governance rules for businesses such as recharge, reward, etc. may include that: accounts within a preset range are restricted from handling the business, etc.

In this embodiment, the target point may be considered as a code segment related to a governance rule of a corresponding business in the program. The target point may include at least one selected from a group consisting of: a calling point, a parameter point, a pointer point, a data encapsulation point, an instantiation point, a data loading point, and a data storage point, etc. The calling point may include information such as a calling method and a called person, etc.; the parameter point may include information such as a parameter name and a type, etc.; the pointer point may include information such as a pointing object type etc.; the data encapsulation point may include information such as a target encapsulation type of data to be encapsulated, etc.; the instantiation point may include information such as a type check of an object to be instantiated, etc.; a data loading point may include information such as a type check of data to be loaded, etc.; the data storage point may include information such as a type of data to be stored, etc., In addition, other code segments may serve as target points for the program and are not exhaustive. It can be considered that due to different compliance governance requirements of different businesses, the corresponding target points in the program may have differences.

In this embodiment, the target points may be identified and marked from the program on the basis of static analysis and/or dynamic analysis in advance. In addition, data relating to the governance rule for the corresponding business may also be determined from the database. After identifying the target points, the target points can be further associated with the data according to the governance rule, namely, information about the database associated with the target points are constructed so as to obtain structured information about each target point.

The structured information may include at least one selected from the group consisting of: database information, data table information, and operation information. The database information may include information such as a database type (such as a relationship type or a graph type) and a name, etc.; the data table information may include information such as a name, etc.; the operation information may include at least one selected from a group consisting of: write, read, delete, query, etc. In addition, other database information associated with the target points may also be included in the structured information, such as initialization information, framework information, event bus information, etc., of the databases. It can be considered that information items contained in the structured information corresponding to each of the target points are the same.

Each target point and the structured information can be correspondingly stored. Accordingly, in the process of executing the program, when executing to a pre-marked target point, structured information corresponding to the target points can be acquired from a corresponding storage space so as to perform a subsequent compliance governance step.

S120, determining target data from the associated database according to the structured information.

In embodiments of the present disclosure, each information item in the structured information may be parsed to automatically identify a database name, a table name, etc. of the database to be accessed. Further, on the basis of parsing results, the associated databases and data tables may be accessed to obtain target data from the associated databases. The target data can be considered to be data related to the governance rule of the corresponding business.

S130, continuing to execute the program in response to the target data satisfying a preset condition.

In embodiments of the present disclosure, the preset condition may be set in advance according to the governance rule of the corresponding business. When the target data satisfies the preset condition, the execution of the program can be continued; when the data does not satisfy the preset condition, the execution of the program may be stopped. This allows compliance governance during executing. In addition, when the execution of the program is stopped, a prompt message that the target data does not satisfy the preset condition may be generated to prompt the user that the executing of the program is terminated.

Illustratively, FIG. 2 is a schematic flow diagram of constructing structured information in the program executing method according to an embodiment of the present disclosure. Referring to FIG. 2, in some alternative implementations, a process of constructing structured information may include:

S210, identifying at least part of target points from the program through a preset static analysis mode.

The quantity and definition of target points to be identified can be predetermined according to the compliance governance requirements of the business. Illustratively, it may be predetermined that three target points need to be identified, and each target point may be defined as “point 1” associated with “compliance governance requirement 1”, “point 2” associated with “compliance governance requirement 2”, and “point 3” associated with “compliance governance requirement 3”.

The preset static analysis mode can be considered as a mode of analyzing the program without executing it. Some of the target points have static features in the codes, which may include, for example, syntax-defining characteristics or data stream transmission characteristics. Illustratively, when a code segment complies with a preset grammar definition, it can be identified as the target point; alternatively, a code segment may be identified as the target point when it meets predetermined data transmission characteristics.

S220, in response to an existence of an unidentified target point, identifying the unidentified target point according to an executing situation of the program through a preset dynamic analysis mode.

After the static analysis is completed, if there is still an unidentified target point, the target point can be further identified through the preset dynamic analysis mode. Among them, the dynamic analysis mode can be considered as a mode of analyzing the program when it is run. Dynamic analysis may involve, among other things, tracking data streams, function calls, code execution paths, etc. to find a relevant dynamic behavior. Through the results of dynamic analysis, not only the unidentified target point can be identified, but also an identified target point can be corrected.

By combining static analysis and dynamic analysis, the target point can be covered more completely and the accuracy can be ensured.

S230, determining the structured information corresponding to an identified target point according to a preset business rule corresponding to the program.

The preset business rule can be understood as a compliance governance rule of the business corresponding to the program. Data relating to the preset business rule may be determined from the database. After the target point is identified, the target point may be further associated with the data according to the preset business rule, namely, the structured information corresponding to the target point is constructed.

In these alternative implementations, by combining the program analysis with the business requirements, the access points of the database in the program can be identified efficiently and accurately, and the analysis results can be associated with the data in the database, which is beneficial to achieve compliance governance in the executing process.

In the technical solution of an embodiment of the present disclosure, in response to a program executing to a target point, structured information corresponding to the target point is determined, wherein the structured information characterizes information about a database associated with the target point; target data is determined from an associated database according to the structured information; and execution of the program is continued in response to the target data satisfying the preset condition. By pre-constructing the structured information to associate the point in the program with the data in the database, it can achieve compliance governance in the process of executing the program and avoid the occurrence of non-compliance calls.

Embodiments of the present disclosure may be combined with various alternatives of the program executing method provided in the embodiment described above. The program executing method provided in this embodiment describes in detail the process of identifying the target point in the process of constructing the structural information. Through the program static analysis based on a preset feature, the target point can be preliminarily delineated; through the program static analysis based on the stain map, the target point can be solved in combination with the context information; through the program dynamic analysis based on an actual data executing situation, the target points that need to be identified can be basically covered.

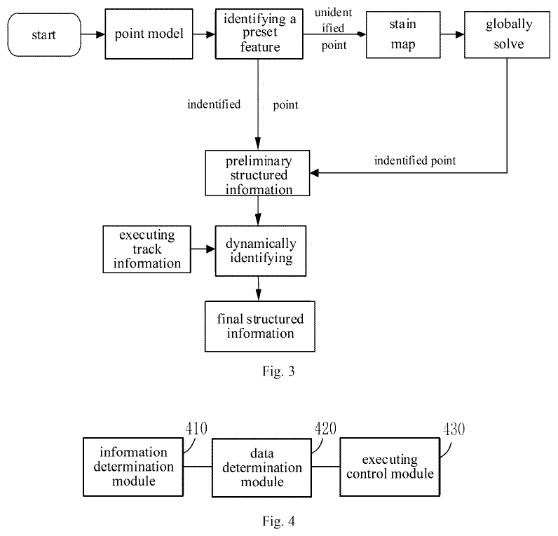

Illustratively, FIG. 3 is a schematic block diagram of data flow for constructing structured information in the program executing method according to an embodiment of the present disclosure. As shown in FIG. 3, in the program executing method provided in the present embodiment, the process of constructing the structured information may include:

S310, acquiring a point model corresponding to the program.

In this embodiment, the program can be mapped into a point model and stored in advance according to an existing program datafication mode. Accordingly, when target point identification is performed, the point model can be acquired from a corresponding storage space.

S320, identifying at least part of the target points from the point model through a preset feature.

In this embodiment, the preset feature includes at least one selected from a group consisting of: a preset parameter definition, a preset grammatical feature, and a preset framework feature. The points that may belong to the target points in the point model can be delineated through static analysis of the preset feature. Illustratively, points that conform to the preset parameter definition, the preset grammatical feature, and the preset framework feature in the point model may be initially identified as corresponding target points.

S330, acquiring a stain map corresponding to the program.

In this embodiment, a coverage of the target points in a preliminary identification result is low, and the target point identification can be further continued on the basis of the static analysis mode of the data flow analysis. The stain map can represent a propagation path of data in the program, and an existing stain map generation method can be used to generate the stain map corresponding to the program. For example, a problem to be solved may be established for the unidentified target point, and a corresponding stain map may be generated by traversing various calling methods in the program, etc.

S340, performing data flow analysis according to the stain map, and identifying at least part of the target points from the program according to a result of the data flow analysis.

The stain map can be globally solved to identify the target points on the basis of an existing data flow analysis mode, including, but not limited to, for example, context-sensitive inter-process analysis, control dependency analysis, and Anderson's pointer analysis. Through a preset problem and global solution, global modeling can be completed, which can further improve the accuracy and coverage of the target points.

Referring to FIG. 3, after step S320 and step S340, the structured information of the identified target point may be preliminarily constructed to obtain preliminary structured information.

S350, acquiring executing track information of the program for data.

After static analysis based on feature and global solution, most of the target points can be covered, but there are some cases that the target points cannot be identified successfully by means of dynamic transferring parameters. At this time, the executing track information about the program for the data can be acquired to perform dynamic analysis of the program. For example, the executing track information may be read from historical data, or the program may be run in real time and the executing track information of the data may be monitored.

S360, identifying the unidentified target point according to the executing track information.

A start position (which may also be referred to as source) and an end position (which may also be referred to as sink) of the data may be determined from the executing track information. The start position can be understood as an initial position of data in the program; and the end position can be understood as a position where the data falls into the database. Since relevant data can be determined from the database according to the preset business rule in advance, the position of the target point in the program can be dynamically identified on the basis of the start position and the end position, such that the target point identification with high coverage can be achieved.

S370, according to a preset business rule corresponding to the program, the structured information corresponding to an identified target point is constructed.

After the target point is dynamically identified, the target point can be associated with the data according to the preset business rule, and the structured information corresponding to the target point can be constructed. In addition, referring to FIG. 3, not only the unidentified target point can be identified by dynamic identification, but also the identified target points and their preliminary structured information can be corrected to obtain final structured information.

The technical solution of an embodiment of the present disclosure describes in detail the process of identifying the target point in the process of constructing the structural information. Through the program static analysis based on a preset feature, the target point can be preliminarily delineated; through the program static analysis based on the stain map, the target point can be solved in combination with the context information; through the program dynamic analysis based on an actual data executing situation, the target points that need to be identified can be basically covered. The program executing method provided by the embodiments of the present disclosure and the program executing method provided by the above-mentioned embodiments fall within the same disclosed concept, technical details which are not described in detail in the present embodiment can be referred to the above-mentioned embodiments, and the same technical features in the present embodiment have the same advantageous effects as the above-mentioned embodiments.

FIG. 4 is a schematic structural diagram of a program executing apparatus according to an embodiment of the present disclosure. The program executing apparatus provided by the present embodiment is applicable to situations where compliance governance occurs during executing of a business program.

As shown in FIG. 4, the program executing apparatus provided in the present embodiment may include:
an information determination module 410, configured to in response to a program executing to a target point, determine structured information corresponding to the target point, the structured information characterizes information about a database associated with the target point;
a data determination module 420, configured to determine target data from the associated database according to the structured information; and
an executing control module 430, configured to continue to execute the program in response to the target data satisfying a preset condition.

In some alternative implementations, the program executing apparatus may further include:
an information construction module, configured to construct the structured information on the basis of the following process to determine structured information corresponding to the target point:
identify at least part of the target points from the program through a preset static analysis mode;
in response to an existence of an unidentified target point, identifying the unidentified target point according to an executing situation of the program through a preset dynamic analysis mode; and
determine the structured information corresponding to an identified target point according to a preset business rule corresponding to the program.

In some alternative implementations, the information construction module may be configured to:
acquire a point model corresponding to the program; and
identify at least part of the target points from the point model through a preset feature,
the preset feature includes at least one selected from a group consisting of: a preset parameter definition, a preset grammatical feature, and a preset framework feature.

In some alternative implementations, the information construction module may be configured to:
acquire a stain map corresponding to the program, wherein the stain map represents a propagation path of data in the program; and
perform data flow analysis according to the stain map, and identify at least part of the target points from the program according to a result of the data flow analysis.

In some alternative implementations, the information construction module may be further configured to:
acquire executing track information about the program for data; and
identify the unidentified target point according to the executing track information.

In some alternative implementations, the target point includes at least one selected from a group consisting of: a calling point, a parameter point, a pointer point, a data encapsulation point, an instantiation point, a data loading point, and a data storage point.

In some alternative implementations, the structured information includes at least one selected from a group consisting of: database information, data table information, and operation information.

The program executing apparatus provided by an embodiment of the present disclosure can perform the program executing method provided by any embodiment of the present disclosure, and has functional modules and advantageous effects corresponding to the method performed.

It should be noted that in the above-mentioned apparatus, the various units and modules included are merely divided according to functional logic, but are not limited to the above-mentioned division, as long as corresponding functions can be realized; in addition, the specific names of each functional unit are merely taken for facilitating mutual distinction, and are not intended to limit the scope of protection of the embodiments of the present disclosure.

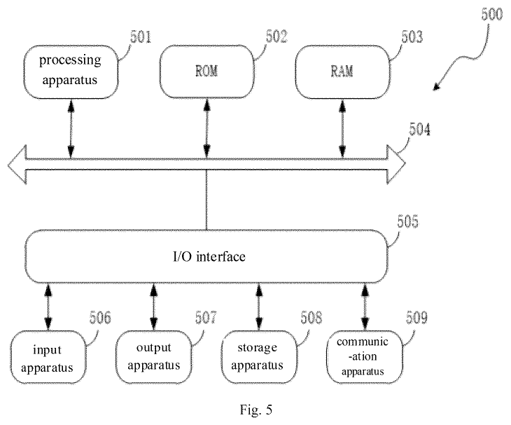

Reference is now made to FIG. 5, which illustrates a schematic structural diagram of an electronic device (e.g. a terminal device or a server in FIG. 5) 500 suitable for implementing the embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (e.g. in-vehicle navigation terminal), etc. and a fixed terminal such as a digital TV, a desktop computer, etc. The electronic device shown in FIG. 5 is only one example and should not impose any limitation on the functionality and scope of use of the embodiments of the present disclosure.

As shown in FIG. 5, the electronic device 500 may include a processing apparatus (e.g. a central processor, a graphics processor, etc.) 501 that may perform various suitable actions and processes in accordance with programs stored in a read-only memory (ROM) 502 or programs loaded from a storage apparatus 508 into a random-access memory (RAM) 503. In the RAM 503, various programs and data required for the operation of the electronic device 500 are also stored. The processing apparatus 501, the ROM 502 and the RAM 503 are connected to each other via a bus 504. An input/output (I/O) interface 505 is also coupled to the bus 504.

In general, the following apparatuses may be connected to the I/O interface 505: an input apparatus 506 including, for example, a touch screen, a touch pad, a keyboard, a mouse, a camera, a microphone, an accelerometer, a gyroscope, etc.; an output apparatus 507 including, for example, a liquid crystal display (LCD), a speaker, a vibrator, etc.; a storage apparatus 508 including, for example, a magnetic tape, a hard disc, etc.; and a communication apparatus 509. The communication apparatus 509 allows wireless or wired communication between the electronic device 500 and other devices to exchange data. Although FIG. 5 illustrates an electronic device 500 having various apparatuses, it should be understood that not all illustrated apparatuses are required to be implemented or provided. More or fewer apparatuses may alternatively be implemented or provided.

In particular, the process described above with reference to the flow diagram may be implemented as computer software programs in accordance with the embodiment of the present disclosure. For example, an embodiment of the present disclosure includes a computer program product including a computer program embodied on a non-transitory computer-readable medium, the computer program including program codes for performing the method illustrated in the flow diagram. In such an embodiment, the computer program may be downloaded and installed from the network via a communication apparatus 509, or from the storage apparatus 508, or from the ROM 502. When the computer program is executed by the processing apparatus 501, the above-described functions defined in the program executing method of the embodiment of the present disclosure are performed.

The electronic device provided by the embodiment of the present disclosure and the program executing method provided by the above-mentioned embodiments fall within the same disclosed concept, technical details which are not described in detail in the present embodiment can be referred to the above-mentioned embodiments, and the present embodiment have the same advantageous effects as the above-mentioned embodiments.

An embodiment of the present disclosure provides a storage medium containing computer-executable instructions, wherein the computer-executable instructions, when executed by a computer processor, perform the program executing method provided by the foregoing embodiments.

Note that the storage medium described above in the present disclosure can be a computer-readable signal medium or a computer-readable storage medium, or any combination of the two. The computer-readable storage medium can be, for example, but not limited to, an electronic, magnetic, optical, electromagnetic, infrared, or semiconductor system, apparatus, or means, or a combination of any of the foregoing. More specific examples of computer-readable storage medium may include, but are not limited to, an electrical connection with one or more wires, a portable computer disc, a hard drive, a random-access memory (RAM), a read-only memory (ROM), an erasable programmable read-only memory (EPROM) or a flash memory (FLASH), a fiber optic, a portable compact disc read-only memory (CD-ROM), an optical storage, a magnetic storage, or any suitable combination thereof. In the present disclosure, the computer-readable storage medium may be any tangible medium that can contain or store executable instructions for use by or in connection with an instruction execution system, apparatus, or means. In the present disclosure, the computer-readable signal medium may include a data signal embodied in baseband or propagated as part of a carrier wave that carries the computer-readable executable instructions. Such propagated data signals may take many forms, including but not limited to electromagnetic signals, optical signals, or any suitable combination of the preceding. The computer-readable signal medium can also be any computer-readable medium other than a computer-readable storage medium, and the computer-readable signal medium can send, propagate, or transport the executable instructions for use by or in connection with the instruction execution system, apparatus, or means. The executable instructions contained on the storage medium may be transmitted over any suitable medium, including but not limited to: a wire, a fiber optic cable, an RF (radio frequency), and the like, or any suitable combination of the foregoing.

In some implementations, clients and servers may communicate using any currently known or future developed network protocol, such as HTTP (Hyper Text Transfer Protocol), and may be interconnected with any form or medium of digital data communication (e.g. a communication network). Examples of communication networks include local area networks (“LAN”), wide area networks (“WAN”), internetworks (e.g. the Internet), and peer-to-peer networks (e.g. the ad hoc peer-to-peer network), as well as any network currently known or developed in the future.

The storage medium may be contained in the electronic device; it may also be present separately and not fitted into the electronic device.

The above-mentioned storage medium carries one or more executable instructions, and when the above-mentioned one or more executable instructions are executed by the electronic device, the electronic device is caused to perform the steps that:
in response to a program executing to a target point, structured information corresponding to the target point is determined, wherein the structured information characterizes information about a database associated with the target point; target data is determined from an associated database according to the structured information; and execution of the program is continued in response to the target data satisfying the preset condition.

The executable instructions for performing the operations of the present disclosure may be written in one or more programming languages or combinations thereof, the programming languages including but not limited to object-oriented programming languages such as Java, Smalltalk, C++, and conventional procedural programming languages, such as the “C” language or similar programming languages. The executable instructions may be executed entirely on the user's computer, partly on the user's computer, as a stand-alone software package, partly on the user's computer and partly on a remote computer, or entirely on a remote computer or server. In the case of involving a remote computer, the remote computer may be connected to the user's computer through any type of network, including a local area network (LAN) or a wide area network (WAN), or may be connected to an external computer (e.g. through an Internet connection using an Internet service provider).

An embodiment of the present disclosure also provides a computer program product, including computer programs that, when executed by a processor, can implement the program executing method provided in any one of the embodiments of the present disclosure.

In the process of implementing the computer program product, computer program codes for performing the operations of the present disclosure may be written in one or more programming languages or combinations thereof, the programming languages including object-oriented programming languages such as Java, Smalltalk, C++, and conventional procedural programming languages, such as the “C” language or similar programming languages. The program codes may be executed entirely on the user's computer, partly on the user's computer, as a stand-alone software package, partly on the user's computer and partly on a remote computer, or entirely on a remote computer or server. In the case of involving a remote computer, the remote computer may be connected to the user's computer through any type of network, including a local area network (LAN) or a wide area network (WAN), or may be connected to an external computer (e.g. through an Internet connection using an Internet service provider).

The flow diagram and block diagram in the drawings illustrate an architecture, a functionality, and an operation of possible implementations of the system, methods, and computer program product according to various embodiments of the present disclosure. In this regard, each block in the flow diagram or block diagram may represent one module, a program segment, or a part of the codes, which include(s) one or more executable instructions for implementing specified logical function(s). It should also be noted that in some alternative implementations, the functions noted in the blocks may occur out of the order noted in the drawings. For example, two blocks shown in succession may, in fact, be executed substantially in parallel, and sometimes in the reverse order, depending upon the functionality involved. It will also be noted that each block of the block diagrams and/or the flow diagrams, and combinations of the blocks in the block diagrams and/or the flow diagrams, can be implemented by special purpose hardware-based systems which perform the specified functions or operations, or combinations of special purpose hardware and computer instructions.

The elements described in connection with the embodiments of the present disclosure may be implemented by means of software or hardware. The names of units and modules in a certain case do not constitute a limitation on the units and modules themselves.

The functions described herein above may be performed, at least in part, by one or more hardware logic components. For example, without limitation, exemplary types of hardware logic components that may be used include: a field programmable gate array (FPGA), an application specific integrated circuit (ASIC), application specific standard parts (ASSP), a system on chip (SOC), a complex programmable logic device (CPLD), etc.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of the machine-readable storage media include an electrical connection based on one or more wires, a portable computer disc, a hard drive, a random access memory (RAM), a read-only memory (ROM), an erasable programmable read-only memory (EPROM or flash memory), an optical fiber, a compact disc read-only memory (CD-ROM), an optical storage, a magnetic storage, or any suitable combination of the foregoing.

According to one or more embodiments of the present disclosure, a program executing method is provided, and the method includes:
in response to a program executing to a target point, determining structured information corresponding to the target point, wherein the structured information represents information of a database associated with the target point;
determining target data from the associated database according to the structured information; and
continuing to execute the program in response to the target data satisfying a preset condition.

According to one or more embodiments of the present disclosure, a program executing method is provided, and the method further includes:
In some alternative implementations, the determining structured information corresponding to the target point a process of constructing the structured information includes constructing the structured information, and the process of constructing the structured information includes:
identifying at least part of target points from the program through a preset static analysis mode;
in response to an existence of an unidentified target point, identifying the unidentified target point according to an executing situation of the program through a preset dynamic analysis mode; and
determining the structured information corresponding to an identified target point according to a preset business rule corresponding to the program.

According to one or more embodiments of the present disclosure, a program executing method is provided, and the method further includes:
In some alternative implementations, the identifying at least part of target points from the program through a preset static analysis mode includes:
acquiring a point model corresponding to the program; and
identifying at least part of the target points from the point model through a preset feature,
the preset feature comprises at least one selected from a group consisting of: a preset parameter definition, a preset grammatical feature, and a preset framework feature.

According to one or more embodiments of the present disclosure, a program executing method is provided, and the method further includes:
In some alternative implementations, the identifying at least part of target points from the program through a preset static analysis mode includes:
acquiring a stain map corresponding to the program, wherein the stain map represents a propagation path of data in the program; and
performing data flow analysis according to the stain map, and identifying at least part of the target points from the program according to a result of the data flow analysis.

According to one or more embodiments of the present disclosure, a program executing method is provided, and the method further includes:
In some alternative implementations, the identifying the unidentified target point according to an executing situation of the program through a preset dynamic analysis mode includes:
acquiring executing track information of the program for data; and
identifying the unidentified target point according to the executing track information.

According to one or more embodiments of the present disclosure, a program executing method is provided, and the method further includes:
In some alternative implementations, the structured information includes at least one selected from a group consisting of: database information, data table information, and operation information.

According to one or more embodiments of the present disclosure, a program executing apparatus is provided, and the method further includes:
In some alternative implementations, the program executing apparatus includes:
an information determination module, configured to in response to a program executing to a target point, determine structured information corresponding to the target point, wherein the structured information represents information of a database associated with the target point;
a data determination module, configured to determine target data from the associated database according to the structured information; and
an executing control module, configured to continue to execute the program in response to the target data satisfying a preset condition.

The foregoing description is only illustrative of the preferred embodiments of the present disclosure and of the technical principles employed. It will be understood by a person skilled in the art that the scope of disclosure referred to in the present disclosure is not limited to the technical solution of a particular combination of the technical features described above, but is intended to cover other technical solutions of any combinations of the features described above or their equivalent features without departing from the concept of the foregoing disclosure. For example, the above-mentioned features and the technical features disclosed (but not limited to) in the present disclosure having similar functions are replaced with each other to form a technical solution.

Further, while operations are depicted in a particular order, this should not be understood to require that the operations shall be performed in the particular order shown or in a sequential order. In certain environment, multi-tasking and parallel processing are advantageous. As such, though specific implementation details have been included in the above-mentioned discussion, these should not be construed as limiting the scope of the present disclosure. Certain features that are described in the context of separate embodiments may also be implemented in combination in a single embodiment. Conversely, various features that are described in the context of a single embodiment can also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A program executing method, comprising:
in response to a program executing to a target point, determining structured information corresponding to the target point, wherein the structured information represents information of a database associated with the target point;
determining target data from the associated database according to the structured information; and
continuing to execute the program in response to the target data satisfying a preset condition.

2. The method according to claim 1, wherein the determining structured information corresponding to the target point a process of constructing the structured information comprises:
identifying at least part of target points from the program through a preset static analysis mode;
in response to an existence of an unidentified target point, identifying the unidentified target point according to an executing situation of the program through a preset dynamic analysis mode; and
determining the structured information corresponding to an identified target point according to a preset business rule corresponding to the program.

3. The method according to claim 2, wherein the identifying at least part of target points from the program through a preset static analysis mode comprises:
acquiring a point model corresponding to the program; and
identifying at least part of the target points from the point model through a preset feature,
wherein the preset feature comprises at least one selected from a group consisting of: a preset parameter definition, a preset grammatical feature, and a preset framework feature.

4. The method according to claim 2, wherein the identifying at least part of target points from the program through a preset static analysis mode comprises:
acquiring a stain map corresponding to the program, wherein the stain map represents a propagation path of data in the program; and
performing data flow analysis according to the stain map, and identifying at least part of the target points from the program according to a result of the data flow analysis.

5. The method according to claim 2, wherein the identifying the unidentified target point according to an executing situation of the program through a preset dynamic analysis mode comprises:
acquiring executing track information of the program for data; and
identifying the unidentified target point according to the executing track information.

6. The method according to claim 1, wherein the target point comprises at least one selected from a group consisting of: a calling point, a parameter point, a pointer point, a data encapsulation point, an instantiation point, a data loading point, and a data storage point.

7. The method according to claim 1, wherein the structured information comprises at least one selected from a group consisting of: database information, data table information, and operation information.

8. An electronic device, comprising:
one or more processors; and
a storage apparatus, configured to store one or more programs,
wherein when the one or more programs are executed by the one or more processors, the one or more processors implement a program executing method, and the method comprises:
in response to a program executing to a target point, determining structured information corresponding to the target point, wherein the structured information represents information of a database associated with the target point;
determining target data from the associated database according to the structured information; and
continuing to execute the program in response to the target data satisfying a preset condition.

9. The electronic device according to claim 8, wherein the determining structured information corresponding to the target point a process of constructing the structured information comprises:
identifying at least part of target points from the program through a preset static analysis mode;
in response to an existence of an unidentified target point, identifying the unidentified target point according to an executing situation of the program through a preset dynamic analysis mode; and
determining the structured information corresponding to an identified target point according to a preset business rule corresponding to the program.

10. The electronic device according to claim 9, wherein the identifying at least part of target points from the program through a preset static analysis mode comprises:
acquiring a point model corresponding to the program; and
identifying at least part of the target points from the point model through a preset feature,
wherein the preset feature comprises at least one selected from a group consisting of: a preset parameter definition, a preset grammatical feature, and a preset framework feature.

11. The electronic device according to claim 9, wherein the identifying at least part of target points from the program through a preset static analysis mode comprises:
acquiring a stain map corresponding to the program, wherein the stain map represents a propagation path of data in the program; and
performing data flow analysis according to the stain map, and identifying at least part of the target points from the program according to a result of the data flow analysis.

12. The electronic device according to claim 9, wherein the identifying the unidentified target point according to an executing situation of the program through a preset dynamic analysis mode comprises:
acquiring executing track information of the program for data; and
identifying the unidentified target point according to the executing track information.

13. The electronic device according to claim 8, wherein the target point comprises at least one selected from a group consisting of: a calling point, a parameter point, a pointer point, a data encapsulation point, an instantiation point, a data loading point, and a data storage point.

14. The electronic device according to claim 8, wherein the structured information comprises at least one selected from a group consisting of: database information, data table information, and operation information.

15. A non-transitory storage medium, comprising computer-executable instructions, wherein the computer-executable instructions, when executed by a computer processor, perform a program executing method, and the method comprises:
in response to a program executing to a target point, determining structured information corresponding to the target point, wherein the structured information represents information of a database associated with the target point;
determining target data from the associated database according to the structured information; and
continuing to execute the program in response to the target data satisfying a preset condition.
